(19) United States
(12) Patent Application Publication
(10) Pub. No.: US 2026/0126625 A1
(43) Pub. Date: May 7, 2026

(54) CAMERA OPTICAL LENS

(71) Applicant: Changzhou AAC Raytech Optronics Co., Ltd., Changzhou City (CN)

(72) Inventors: Lu Pan, Changzhou (CN); Yinghui Yuan, Changzhou (CN)

(21) Appl. No.: 19/083,399

(22) Filed: Mar. 18, 2025

Related U.S. Application Data
(63) Continuation of application No. PCT/CN2024/129805, filed on Nov. 5, 2024.

(51) Int. Cl. G02B 13/00; G02B 9/60

(52) U.S. Cl. CPC G02B 13/0045; G02B 9/60; G02B 13/0055

(57) ABSTRACT

The present disclosure relates to the field of optical lenses, and discloses a camera optical lens sequentially including five lenses from an object side to an image side: a first lens having positive refractive power, a second lens having negative refractive power, a third lens having positive refractive power, a fourth lens having refractive power, and a fifth lens having negative refractive power; and following relational expressions are satisfied: 0.50≤(R5+R6)/(R5-R6)≤0.81, −4.00≤(f2+f5)/f≤−2.50, 0.60≤d9/d8≤2.00, 2.80≤R9/R10≤6.00, and −8.00≤(R7+R8)/f≤−4.00. The camera optical lens provided by the present disclosure can satisfy the design requirements of large aperture, ultra-thinness and wide angle.

### TECHNICAL FIELD

The present disclosure relates to the field of optical lens, and in particular, to a camera optical lens applied to handheld terminal devices such as smart phones, digital cameras, and camera devices such as monitors, PC lenses.

### BACKGROUND

In recent years, with the rise of various smart devices, the demand for a miniaturized camera optical lens has gradually increased. Since pixel size of the optical sensor is reduced, and the current electronic product has a development trend of light weight, thinness and being portable, the miniaturized camera optical lens with good imaging quality has become a mainstream of the current market. In order to obtain better imaging quality, a multi-lens structure is mostly used. In addition, with the development of technology and the increase of user's diversified requirements, under the condition that the pixel area of the photosensitive device is continuously reduced and the requirements on the imaging quality of the system are continuously improved, a structure with five lenses gradually appears in the lens design. There is an urgent need for a camera optical lens with excellent optical performance, small size, and fully corrected aberrations.

### SUMMARY

In view of the above problems, a main object of the present disclosure is to provide a camera optical lens, meeting design requirements of large aperture, ultra-thinness and wide angle while having excellent optical performance.

In order to realize the above object, the technical solutions of the present disclosure provide a camera optical lens. The camera optical lens sequentially including five lenses from an object side to an image side: a first lens having positive refractive power, a second lens having negative refractive power, a third lens having positive refractive power, a fourth lens having refractive power, and a fifth lens having negative refractive power. A focal length of the camera optical lens is defined as f, a focal length of the second lens is f2, a focal length of the fifth lens is f5, an on-axis distance from an image side surface of the fourth lens to an object side surface of the fifth lens is defined as d8, an on-axis thickness of the fifth lens is defined as d9, a central curvature radius of an object side surface of the third lens is defined as R5, and a central curvature radius of an image side surface of the third lens is defined as R6, a central curvature radius of an object side surface of the fourth lens is defined as R7, a central curvature radius of an image side surface of the fourth lens is defined as R8, a central curvature radius of an object side surface of the fifth lens is defined as R9, a central curvature radius of an image side surface of the fifth lens is defined as R10, and following relational expressions are satisfied:

$$0.5 ⩽ ( R 5 + R 6 ) / ( R 5 - R 6 ) ⩽ 0.81 ;$$

$$- 4. ⩽ ( f 2 + f 5 ) / f ⩽ - 2.5 ;$$

$$0.6 ⩽ d 9 / d 8 ⩽ 2. ;$$

$$2.8 ⩽ R 9 / R 10 ⩽ 6. ; and$$

$$- 8. ⩽ ( R 7 + R 8 ) / f ⩽ - 4. .$$

As an improvement, an on-axis thickness of the second lens is defined as d3, an on-axis thickness of the third lens is defined as d5, an on-axis thickness of the fourth lens is defined as d7, and a following relational expression is satisfied:

$$5. ⩽ ( d 5 + d 7 ) / d 3 ⩽ 8. .$$

As an improvement, a total optical length from an object side surface of the first lens to an image plane of the camera optical lens along an optic axis is defined as TTL, and a following relational expression is satisfied:

$$1.05 ⩽ TTL / f ⩽ 1.35 .$$

As an improvement, an object side surface of the first lens is convex in a paraxial region, and an image side surface of the first lens is concave in the paraxial region; and
a focal length of the first lens is defined as f1, a central curvature radius of the object side surface of the first lens is defined as R1, a central curvature radius of the image side surface of the first lens is defined as R2, an on-axis thickness of the first lens is defined as d1, a total optical length from an object side surface of the first lens to an image plane of the camera optical lens along an optic axis is defined as TTL, and following relational expressions are satisfied:

$$0.36 ⩽ f 1 / f ⩽ 1.46 ;$$

$$- 3.2 ⩽ ( R 1 + R 2 ) / ( R 1 - R 2 ) ⩽ - 0.69 ; and$$

$$0.07 ⩽ d 1 / TTL ⩽ 0.25 .$$

As an improvement, an object side surface of the second lens is convex in a paraxial region, and an image side surface of the second lens is concave in the paraxial region; and
a central curvature radius of an object side surface of the second lens is defined as R3, a central curvature radius of an image side surface of the second lens is defined as R4, an on-axis thickness of the second lens is d3, and a total optical length from an object side surface of the first lens to an image plane of the camera optical lens along an optic axis is defined as TTL, and following relational expressions are satisfied:

$$- 6.07 ⩽ f 2 / f ⩽ - 1.14 ;$$

$$1.37 ⩽ ( R 3 + R 4 ) / ( R 3 - R 4 ) ⩽ 5.07 ; and$$

$$0.02 ⩽ d 3 / TTL ⩽ 0.08 .$$

As an improvement, an object side surface of the third lens is convex in a paraxial region, and an image side surface of the third lens is convex in the paraxial region; and
a focal length of the third lens is defined as f3, an on-axis thickness of the third lens is defined as d5, and a total optical length from an object side surface of the first lens to an image plane of the camera optical lens along an optic axis is defined as TTL, and following relational expressions are satisfied:

$$2.31 ⩽ f 3 / f ⩽ 19.9 ; and$$

$$0.06 ⩽ d 5 / TTL ⩽ 0.25 .$$

As an improvement, an object side surface of the fourth lens is concave in a paraxial region, and an image side surface of the fourth lens is convex in the paraxial region; and
a focal length of the fourth lens is f4, and an on-axis thickness of the fourth lens is defined as d7, and a total optical length from an object side surface of the first lens to an image plane of the camera optical lens along an optic axis is defined as TTL, and following relational expressions are satisfied:

$$- 39.5 ⩽ f 4 / f ⩽ 1.97 ;$$

$$- 10.8 ⩽ ( R 7 + R 8 ) / ( R 7 - R 8 ) ⩽ 2.11 ; and$$

$$0.06 ⩽ d 7 / TTL ⩽ 0.25 .$$

As an improvement, an object side surface of the fifth lens is convex in a paraxial region, and an image side surface of the fifth lens is concave in the paraxial region; and
a total optical length from an object side surface of the first lens to an image plane of the camera optical lens along an optic axis is defined as TTL, and following relational expressions are satisfied:

$$- 1.84 ⩽ f 5 / f ⩽ - 0.53 ; and$$

$$0.05 ⩽ d 9 / TTL ⩽ 02 \; 0 .$$

As an improvement, a total optical length from an object side surface of the first lens to an image plane of the camera optical lens along an optic axis is defined as TTL, and a maximum image height of the camera optical lens is defined as IH, and a following relational expression is satisfied:

$$TTL / IH ⩽ 1.79 .$$

As an improvement, a combined focal length of the first lens and the second lens is defined as f12, and a following relational expression is satisfied:

$$0. 43 ⩽ f 12 / f ⩽ 2.1 7 .$$

The present disclosure has following beneficial effects: the camera optical lens as described in the present disclosure has good optical performance of large aperture, wide-angle and ultra-thinness, and is particularly suitable for a mobile phone camera lens assembly, and a WEB camera lens composed of camera elements such as CCD, CMOS for high pixels.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic diagram of a camera optical lens according to Example 1 of the present disclosure;

FIG. 2 is a schematic diagram of longitudinal aberration of the camera optical lens shown in FIG. 1;

FIG. 3 is a schematic diagram of lateral color of the camera optical lens shown in FIG. 1;

FIG. 4 is a schematic diagram of field curvature and distortion of the camera optical lens shown in FIG. 1;

FIG. 5 is a structural schematic diagram of a camera optical lens according to Example 2 of the present disclosure;

FIG. 6 is a schematic diagram of longitudinal aberration of the camera optical lens shown in FIG. 5;

FIG. 7 is a schematic diagram of lateral color of the camera optical lens shown in FIG. 5;

FIG. 8 is a schematic diagram of field curvature and distortion of the camera optical lens shown in FIG. 5;

FIG. 9 is a structural schematic diagram of a camera optical lens according to Example 3 of the present disclosure;

FIG. 10 is a schematic diagram of longitudinal aberration of the camera optical lens shown in FIG. 9;

FIG. 11 is a schematic diagram of lateral color of the camera optical lens shown in FIG. 9;

FIG. 12 is a schematic diagram of field curvature and distortion of the camera optical lens shown in FIG. 9;

FIG. 13 is a structural schematic diagram of a camera optical lens according to Example 4 of the present disclosure;

FIG. 14 is a schematic diagram of longitudinal aberration of the camera optical lens shown in FIG. 13;

FIG. 15 is a schematic diagram of lateral color of the camera optical lens shown in FIG. 13;

FIG. 16 is a schematic diagram of field curvature and distortion of the camera optical lens shown in FIG. 13;

FIG. 17 is a schematic structural diagram of a camera optical lens according to Comparative Example;

FIG. 18 is a schematic diagram of longitudinal aberration of the camera optical lens shown in FIG. 17;

FIG. 19 is a schematic diagram of lateral color of the camera optical lens shown in FIG. 17; and

FIG. 20 is a schematic diagram of field curvature and distortion of the camera optical lens shown in FIG. 17.

### DESCRIPTION OF EMBODIMENTS

In order to more clearly illustrate objectives, technical solutions, and advantages of embodiments of the present disclosure, the technical solutions in embodiments of the present disclosure are clearly and completely described in details with reference to the accompanying drawings. However, those skilled in the art will appreciate that in various embodiments of the present disclosure, numerous technical details are set forth for the reader to better understand the present disclosure. However, even without these technical details and various variations and modifications based on the following embodiments, the technical solutions claimed in the present disclosure can still be implemented.

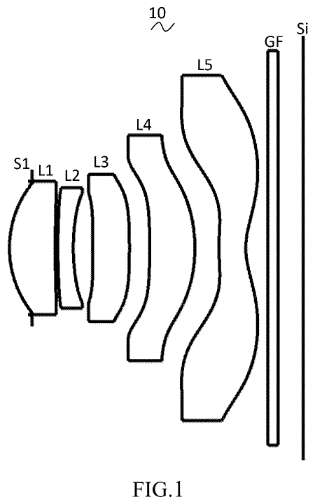

Referring to FIG. 1 to FIG. 16, the technical solutions of the present disclosure provide camera optical lenses 10, 20, 30 and 40. FIG. 1, FIG. 5, FIG. 9, and FIG. 13 show camera optical lenses 10, 20, 30, and 40 of the present disclosure, and the camera optical lenses 10, 20, 30, and 40 include five lenses. The camera optical lens sequentially includes from an object side to an image side: an aperture S1, a first lens L1, a second lens L2, a third lens L3, and a fourth lens L4, and a fifth lens L5. Optical elements such as a grating filter GF may be provided between the fifth lens L5 and the image plane Si.

In this embodiment, the first lens L1 is made of plastic material, the second lens L2 is made of plastic material, the third lens L3 is made of plastic material, the fourth lens L4 is made of plastic material, and the fifth lens L5 is made of plastic material. The lenses may also be made of other materials.

The first lens L1 has positive refractive power. The second lens L2 has negative refractive power. The third lens L3 has positive refractive power. The fourth lens L4 has refractive power. The fifth lens L5 has negative refractive power. In other embodiments, each lens may also have other refractive powers.

A central curvature radius of an object side surface of the third lens L3 is defined as R5, a central curvature radius of an image side surface of the third lens L3 is defined as R6, and a following relational expression is satisfied: 0.50≤(R5+R6)/(R5−R6)≤0.81, which specifies a shape of the third lens L3. Within the above range of the relational expression, it is beneficial to correct the astigmatism and distortion of the camera optical lens, so that the |Distortion|≤2.5%, thereby reducing the possibility of vignetting.

A focal length of the camera optical lens is defined as f, a focal length of the second lens L2 is defined as f2, a focal length of the fifth lens L5 is defined as f5, and a following relational expression is satisfied: −4.00≤(f2+f5)/f<−2.50. Within the above range of the relational expression, by reasonably allocating the focal length of the camera optical lens, the camera optical lens can have better imaging quality and lower sensitivity.

An on-axis distance from an image side surface of the fourth lens to an object side surface of the fifth lens is defined as d8, an on-axis thickness of the fifth lens is defined as d9, and a following relational expression is satisfied: 0.60≤d9/d8≤2.00, which specifies the ratio of the on-axis thickness of the fifth lens L5 to the air gap between the fourth lens L4 and the fifth lens L5. Within the above range of the relational expression, by reasonably allocating the air gap between the lenses, it is beneficial to reduce the assembly difficulty in the actual production process and improve the yield.

A central curvature radius of an object side surface of the fifth lens L5 is defined as R9, and a central curvature radius of an image side surface of the fifth lens L5 is defined as R10, and a following relational expression is satisfied: 2.80≤R9/R10≤6.00. Within the above range of the relational expression, it specifies a shape of the fifth lens L5, and can alleviate the degree of deviation of light passing through the lens, effectively correct the chromatic aberration, and make the chromatic aberration |LC|≤2.0 μm.

A central curvature radius of the object side surface of the fourth lens L4 is defined as R7, and a central curvature radius of the image side surface of the fourth lens L4 is defined as R8, a following relational expression is satisfied: −8.00≤(R7+R8)/f≤−4.00. Within the above range of the relational expression, it is convenient to adjust and control the refractive power of the fourth lens L4, so that the fourth lens L4 corrects the on-axis chromatic aberration and the off-axis lateral color of the light after passing through the third lens L3, thereby improving the imaging quality.

When the above relational expression is satisfied, the camera optical lenses 10, 20, 30, and 40 have good optical performance and may satisfy the design requirements of large aperture, wide-angle and ultra-thinness. According to the characteristics of the camera optical lenses 10, 20, 30, and 40, the camera optical lenses 10, 20, 30, and 40 are particularly suitable for mobile phone camera lens assembly and the WEB camera lens composed of camera elements such as CCD and CMOS for high pixels.

Based on the above relational expressions and the achievable functions, the characteristics of each lens are further defined as follows.

An object side surface of the first lens L1 is convex in a paraxial region, and an image side surface of the first lens L1 is concave in the paraxial region. An object side surface of the second lens L2 is convex in the paraxial region, and an image side surface of the second lens L2 is concave in the paraxial region. An object side surface of the third lens L3 is convex in the paraxial region, and an image side surface of the third lens L3 is convex in the paraxial region. An object side surface of the fourth lens L4 is concave in the paraxial region, and an image side surface of the fourth lens L4 is convex in the paraxial region. An object side surface of the fifth lens L5 is convex in the paraxial region, and an image side surface of the fifth lens L5 is concave in the paraxial region. In other embodiments, each lens may have other surface types.

An on-axis thickness of the second lens L2 is defined as d3, an on-axis thickness of the third lens L3 is defined as d5, an on-axis thickness of the fourth lens L4 is defined as d7, and a following relational expression is satisfied: 5.00≤(d5+d7)/d3≤8.00. By allocating on-axis thicknesses of the second lens L2, the third lens L3, and the fourth lens L4, it is beneficial to compress the total optical length of the camera optical lens within the relational expression.

A total optical length from an object side surface of the first lens to an image plane of the camera optical lens along an optic axis is defined as TTL, and a following relational expression is satisfied: 1.05≤TTL/f≤1.35. It specifies a telescopic ratio, and by letting the telescopic ratio be less than the upper limit value of the relational expression, the TTL can be controlled to be shorter, making it easier to achieve miniaturization. On the other hand, by letting the telescopic ratio be greater than the lower limit value of the relational expression, distortion and on-axis chromatic aberration can be easily corrected, and thus maintaining good optical performance of the camera optical system.

A focal length of the first lens L1 is f1, and a following relational expression is satisfied: 0.36≤f1/f<1.46, which specifies a ratio of a focal length of the first lens L1 to a focal length of the camera optical lens. Within the above range of the relational expression, the camera optical lens has better imaging quality and lower sensitivity by reasonably allocating optical focal lengths of the camera optical lens. Optionally, a following relational expression is satisfied: a following relational expression is satisfied: 0.57≤f1/f≤1.17.

A central curvature radius of the object side surface of the first lens L1 is defined as R1, a central curvature radius of the image side surface of the first lens L1 is defined as R2, and a following relational expression is satisfied: −3.20≤(R1+R2)/(R1-R2)≤−0.69. The shape of the first lens L1 is reasonably controlled, so that the first lens L1 may effectively correct the spherical aberration of the system. Optionally, a following relational expression is satisfied: a following relational expression is satisfied: −2.00≤(R1+R2)/(R1-R2)≤−0.86.

An on-axis thickness of the first lens L1 is d1, and a following relational expression is satisfied: 0.07≤d1/TTL≤0.25, which specifies a ratio of the on-axis thickness of the first lens L1 to the total optical length, which helps to control the thickness of the first lens L1 within the above range of the relational expression, facilitates injection molding, and helps to receive light, thereby ensuring a wide-angle design. Optionally, a following relational expression is satisfied: a following relational expression is satisfied: 0.11≤d1/TTL≤0.20.

The camera optical lens further satisfies the following conditions: −6.07<f2/f≤−1.14 which specifies the ratio of the focal length f2 of the second lens L2 to the focal length f of the camera optical lens, and can effectively balance the field curvature of the camera optical lens within the above range of the relational expression. Optionally, a following relational expression is satisfied: a following relational expression is satisfied: −3.80≤f2/f≤−1.42.

A central curvature radius of an object side surface of the second lens L2 is R3, a central curvature radius of an image side surface of the second lens L2 is R4, and a following relational expression is satisfied: 1.37≤(R3+R4)/(R3−R4)≤5.07. A shape of the second lens L2 is specified. Within the above range of the relational expression, as the lens develops towards ultra-thinness and wide-angles, it is beneficial to correct an on-axis chromatic aberration problem. Optionally, a following relational expression is satisfied: a following relational expression is satisfied: 2.19≤(R3+R4)/(R3−R4)≤4.06.

The camera optical lens satisfies the following conditions: 0.02≤d3/TTL≤0.08. Within the above range of the relational expression, it is beneficial to achieve ultra-thinness. Optionally, a following relational expression is satisfied: a following relational expression is satisfied: 0.03≤d3/TTL≤0.06.

A focal length of the third lens L3 is defined as f3, and satisfies the following relational expression: 2.31≤f3/f≤19.90, which specifies a ratio of a focal length of the third lens L3 to a focal length f of the camera optical lens. Within the above range of the relational expression, by reasonably allocating the focal length of the camera optical lens, the camera optical lens can have better imaging quality and lower sensitivity. Optionally, a following relational expression is satisfied: a following relational expression is satisfied: 3.69≤f3/f≤15.92.

The camera optical lens further satisfies the following conditions: 0.06≤d5/TTL≤0.25. Within the above range of the relational expression, it is beneficial to achieve ultra-thinness. Optionally, a following relational expression is satisfied: a following relational expression is satisfied: 0.10≤d5/TTL≤0.20.

A focal length of the fourth lens L4 is defined as f4, and a following relational expression is satisfied: −39.50≤f4/f<1.97. The system has better imaging quality and lower sensitivity by reasonable distribution of refractive power. Optionally, a following relational expression is satisfied: a following relational expression is satisfied: −24.69≤f4/f≤1.58.

The camera optical lens further satisfies the following conditions: 10.80≤(R7+R8)/(R7−R8)≤2.11, which specifies a shape of the fourth lens L4. Within the above range of the relational expression, it is beneficial to correct the problems such as the aberration of off-axis angles with the development of the ultra-thinness and wide-angle. Optionally, a following relational expression is satisfied: a following relational expression is satisfied:

$$6.75 \leq ( R 7 + R 8 ) / ( R 7 - R 8 ) \leq 1.69 .$$

The camera optical lens further satisfies the following conditions: 0.06≤d7/TTL≤0.25. Within the above range of the relational expression, it is beneficial to achieve ultra-thinness. Optionally, a following relational expression is satisfied: a following relational expression is satisfied: 0.10≤d7/TTL≤0.20.

A focal length of the fifth lens L5 is f5, and a following relational expression is satisfied: −1.84≤f5/f<−0.53. The limitation of the fifth lens L5 may effectively make a light angle of the camera optical lens smooth, and reduce tolerance sensitivity. Optionally, a following relational expression is satisfied: a following relational expression is satisfied: −1.15≤f5/f≤−0.66.

The fifth lens L5 further satisfies the following relational expression: 0.05≤d9/TTL≤0.20. Within the above range of the relational expression, it is beneficial to achieve ultra-thinness. Optionally, a following relational expression is satisfied: a following relational expression is satisfied: 0.07≤d9/TTL≤0.16.

A maximum image height of the camera optical lens is IH, and a following relational expression is satisfied: TTL/IH≤1.79. Within the above range of the relational expression, it is beneficial to achieve ultra-thinness.

A combined focal length of the first lens L1 and the second lens L2 is f12, and a following relational expression is satisfied: 0.43≤f12/f≤2.17. Within the above range of the relational expression, aberration and distortion of the camera optical lens may be eliminated, and the back focal length of the camera optical lens may be suppressed, thereby maintaining the miniaturization of the image lens system assembly. Optionally, a following relational expression is satisfied: a following relational expression is satisfied: 0.70≤f12/f≤1.74.

A field of view FOV of the camera optical lens is greater than or equal to 79.00°, thereby achieving wide-angle.

An F-number FNO of the camera optical lens is smaller than or equal to 1.94, thereby achieving large-aperture and good imaging performance of the camera optical lens. As an improvement, the FNO is smaller than or equal to 1.90.

The camera optical lens of the present disclosure will be described below with embodiments. The reference signs recited in each embodiment are shown below. The units of the focal length, the on-axis distance, the central curvature radius, and the on-axis thickness are mm.

TTL refers to a total optical length from the object side surface of the first lens to an image plane of the camera optical lens along an optic axis (the on-axis distance from the object-side surface of the first lens L1 to the image plane Si), and its unit is mm.

F-number FNO refers to a ratio of the effective focal length of the camera optical lens to the entrance pupil diameter of the camera optical lens.

The technical solutions of the present disclosure will be specifically described in four Examples. Meanwhile, a Comparative Example is provided as a reference, and the technical effects of the present disclosure cannot be achieved when the ranges of the above relational expressions are exceeded.

### Example 1

Table 1 and Table 2 show design data of the camera optical lens 10 according to Example 1 of the present disclosure. In this Example, the fourth lens L4 has positive refractive power.

TABLE 1

| | R | d | | nd | | vd | |
|---|---|---|---|---|---|---|---|
| S1 | ∞ | d0= | −0.456 | | | | |
| R1 | 1.956 | d1= | 0.920 | nd1 | 1.5444 | ν1 | 55.82 |
| R2 | 8.460 | d2= | 0.055 | | | | |
| R3 | 6.964 | d3= | 0.314 | nd2 | 1.6700 | ν2 | 19.39 |
| R4 | 3.643 | d4= | 0.393 | | | | |
| R5 | 175.640 | d5= | 0.739 | nd3 | 1.5444 | ν3 | 55.82 |
| R6 | −18.498 | d6= | 0.409 | | | | |
| R7 | −17.471 | d7= | 0.913 | nd4 | 1.5444 | ν4 | 55.82 |
| R8 | −2.952 | d8= | 0.486 | | | | |
| R9 | 3.762 | d9= | 0.540 | nd5 | 1.5346 | ν5 | 55.69 |
| R10 | 1.316 | d10= | 0.446 | | | | |
| R11 | ∞ | d11= | 0.210 | ndg | 1.5168 | νg | 64.17 |
| R12 | ∞ | d12= | 0.505 | | | | |

The meaning of each symbol is as follows.
S1: aperture;
R: curvature radius at the center of the optical surface;
R1: central curvature radius of the object side surface of the first lens L1;
R2: central curvature radius of the image side surface of the first lens L1;
R3: central curvature radius of the object side surface of the second lens L2;
R4: central curvature radius of the image side surface of the second lens L2;
R5: central curvature radius of the object side surface of the third lens L3;
R6: central curvature radius of the image side surface of the third lens L3;
R7: central curvature radius of the object side surface of the fourth lens L4;
R8: central curvature radius of the image side surface of the fourth lens L4;
R9: central curvature radius of the object side surface of the fifth lens L5;
R10: central curvature radius of the image side surface of the fifth lens L5;
R11: central curvature radius of the object side surface of the grating filter GF;
R12: central curvature radius of the image side surface of the grating filter GF;
d: on-axis thickness of lenses, and on-axis distance between lenses;
d0: on-axis distance from the aperture S1 to the object side surface of the first lens L1;
d1: on-axis thickness of the first lens L1;
d2: on-axis distance from the image side surface of the first lens L1 to the object side surface of the second lens L2;
d3: on-axis thickness of the second lens L2;
d4: on-axis distance from the image side surface of the second lens L2 to the object side surface of the third lens L3;
d5: on-axis thickness of the third lens L3;
d6: on-axis distance from the image side surface of the third lens L3 to the object side surface of the fourth lens L4;
d7: on-axis thickness of the fourth lens L4;
d8: on-axis distance from the image side surface of the fourth lens L4 to the object side surface of the fifth lens L5;
d9: on-axis thickness of the fifth lens L5;
d10: on-axis distance from the image side surface of the fifth lens L5 to the object side surface of the grating filter GF;
d11: on-axis thickness of the grating filter GF;
d12: on-axis distance from the image side surface of the grating filter GF to the image plane Si;
nd: refractive index of d line (d line corresponds to green light with a wavelength of 550 nm);
nd1: refractive index of d line of the first lens L1;
nd2: refractive index of d line of the second lens L2;
nd3: refractive index of d line of the third lens L3;
nd4: refractive index of d line of the fourth lens LA;
nd5: refractive index of d line of the fifth lens L5;
ndg: refractive index of d line of the grating filter GF;
vd: abbe number;
v1: abbe number of the first lens L1;
v2: abbe number of the second lens L2;
v3: abbe number of the third lens L3;
v4: abbe number of the fourth lens L4;
v5: abbe number of the fifth lens L5; and
vg: abbe number of the grating filter GF.

Table 2 shows aspheric surface data of each lens in the camera optical lens 10 according to Example 1 of the present disclosure.

TABLE 2

| | Conic coefficient | Aspherical Coefficient | | | | |
|---|---|---|---|---|---|---|
| | k | A4 | A6 | A8 | A10 | A12 |
| R1 | −7.9531E−02 | 9.0513E−05 | 8.9226E−03 | −2.4575E−02 | 3.9735E−02 | −2.9796E−02 |
| R2 | −2.3506E+02 | −6.8546E−02 | 9.4112E−02 | −1.8380E−02 | −7.2924E−02 | 2.9466E−02 |
| R3 | −8.1761E+01 | −1.0178E−01 | 1.6117E−01 | −5.4052E−02 | −8.9324E−02 | 5.4080E−02 |
| R4 | −7.6166E+00 | −1.4563E−02 | 1.6487E−02 | 2.3197E−01 | −6.4000E−01 | 8.2930E−01 |
| R5 | −1.6861E+06 | −4.3922E−02 | −6.2287E−02 | 1.5561E−01 | −2.0557E−01 | 3.4774E−02 |
| R6 | 1.5556E+02 | −5.0074E−02 | −8.6186E−03 | 3.5054E−03 | −1.6840E−02 | 2.0234E−02 |
| R7 | −4.3558E+00 | −1.5761E−02 | −5.9246E−02 | 6.7134E−02 | −5.2408E−02 | 1.4044E−02 |
| R8 | 0.0000E+00 | −1.7939E−02 | −5.5235E−02 | 1.2873E−01 | −1.3059E−01 | 7.2262E−02 |
| R9 | 0.0000E+00 | −3.0428E−01 | 1.5389E−01 | −6.4088E−02 | 2.1850E−02 | −5.1369E−03 |
| R10 | −1.0000E+00 | −2.9372E−01 | 1.5709E−01 | −5.9673E−02 | 1.5185E−02 | −2.5539E−03 |
| | Conic coefficient | Aspherical Coefficient | | | | |
| | k | A14 | A16 | A18 | A20 | A22 |
| R1 | −7.9531E−02 | 7.8415E−04 | 1.0194E−02 | −1.3002E−03 | −2.0621E−03 | −8.9055E−04 |
| R2 | −2.3506E+02 | 7.7128E−02 | −4.9418E−02 | −4.3872E−02 | 1.8679E−02 | 3.8529E−02 |
| R3 | −8.1761E+01 | 7.6034E−02 | −1.7098E−02 | −9.4721E−02 | 1.3421E−02 | 5.3037E−02 |
| R4 | −7.6166E+00 | −5.1240E−01 | 1.2011E−01 | −4.7633E−02 | 9.0434E−03 | 9.1180E−02 |
| R5 | −1.6861E+06 | 1.5187E−01 | −2.8500E−02 | −1.2380E−01 | −1.4828E−02 | 5.5756E−02 |
| R6 | 1.5556E+02 | −7.5091E−03 | −1.5326E−03 | 4.5731E−05 | 1.5630E−03 | −2.3889E−04 |
| R7 | −4.3558E+00 | 3.5332E−03 | −1.1288E−03 | −5.0864E−04 | 2.1334E−05 | 4.8304E−05 |
| R8 | 0.0000E+00 | −2.2814E−02 | 4.1227E−03 | −3.9855E−04 | 1.6034E−05 | 0.0000E+00 |
| R9 | 0.0000E+00 | 7.7292E−04 | −7.1105E−05 | 3.6518E−06 | −8.0418E−08 | 0.0000E+00 |
| R10 | −1.0000E+00 | 2.7897E−04 | −1.9004E−05 | 7.3344E−07 | −1.2253E−08 | 0.0000E+00 |
| | Conic coefficient | Aspherical Coefficient | | | | |
| | k | A24 | A26 | A28 | A30 | A32 |
| R1 | −7.9531E−02 | 5.2631E−04 | 4.7768E−04 | 3.8524E−05 | −2.5726E−04 | 6.9920E−05 |
| R2 | −2.3506E+02 | −1.7096E−02 | −7.7899E−03 | −1.0500E−03 | 5.5230E−03 | −1.5799E−03 |
| R3 | −8.1761E+01 | 5.9623E−03 | 4.1403E−03 | −6.1138E−02 | 4.7036E−02 | −1.0490E−02 |
| R4 | −7.6166E+00 | −1.0895E−02 | −6.3306E−02 | −1.9589E−02 | 5.7954E−02 | −1.8867E−02 |
| R5 | −1.6861E+06 | 1.1655E−01 | −6.6829E−02 | −1.2488E−01 | 1.2624E−01 | −3.2692E−02 |
| R6 | 1.5556E+02 | −1.6440E−04 | −1.0934E−04 | 3.9645E−05 | 3.3676E−05 | −1.1081E−05 |
| R7 | −4.3558E+00 | 9.4260E−06 | −2.0999E−06 | −1.2510E−06 | 8.3270E−08 | 3.3846E−08 |
| R8 | 0.0000E+00 | 0.0000E+00 | 0.0000E+00 | 0.0000E+00 | 0.0000E+00 | 0.0000E+00 |
| R9 | 0.0000E+00 | 0.0000E+00 | 0.0000E+00 | 0.0000E+00 | 0.0000E+00 | 0.0000E+00 |
| R10 | −1.0000E+00 | 0.0000E+00 | 0.0000E+00 | 0.0000E+00 | 0.0000E+00 | 0.0000E+00 |

For convenience, the aspheric surface of each lens surface uses the aspheric surface shown in the following relational expression (1). However, the present disclosure is not limited to the aspheric polynomial form shown in relational expression (1).

$$z = ( c {r}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} + A 32 {r}^{32} \qquad ( 1 )$$

Where k is a conic coefficient, A4, A6, A8, A10, A12, A14, A16, A18, A20, A22, A24, A26, A28, A30 and A32 are aspheric coefficients, c is a curvature at a center of an optical surface, r is a vertical distance between a point on an aspheric curve and an optical axis, and z is an aspheric depth (a vertical distance between a point on the aspherical surface having a distance r from the optical axis, and a tangent plane tangent to a vertex on the aspherical optical axis).

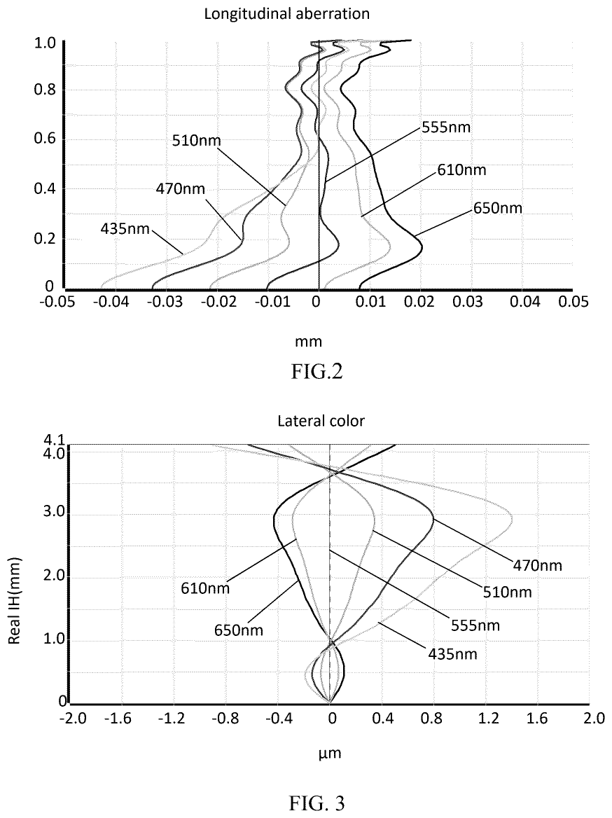

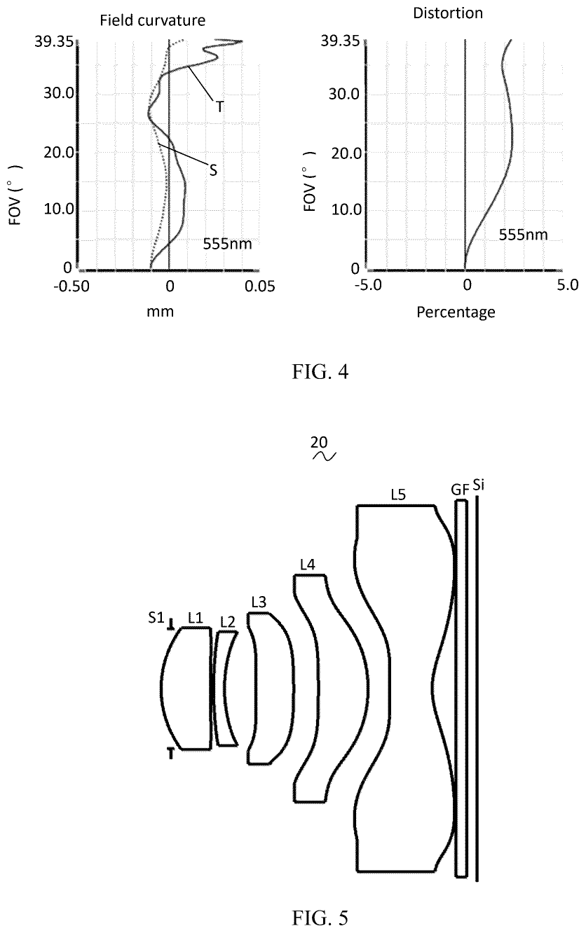

FIG. 2 and FIG. 3 respectively show longitudinal aberration and lateral color of light with wavelengths of 650 nm, 610 nm, 555 nm, 510 nm, 470 nm, and 435 nm after passing through the camera optical lens 10 according to Example 1. FIG. 4 shows field curvature and distortion of light with a wavelength of 555 nm after passing through the camera optical lens 10 according to Example 1, the field curvature S in FIG. 4 is a field curvature in a sagittal direction, and Tis a field curvature in a meridian direction.

In this Example, an entrance pupil diameter ENPD of the camera optical lens 10 is 2.587 mm, a full field of view image height IH is 4.096 mm, and a field of view FOV in a diagonal direction of the full field of view is 78.67°. The camera optical lens 10 satisfies the design requirements of large aperture, wide-angle and ultra-thinness, and the on-axis and off-axis chromatic aberration thereof are fully corrected, and has good optical performance.

### Example 2

The meaning of the reference signs of Example 2 is the same as that of Example 1.

FIG. 5 shows a camera optical lens 20 according to Example 2 of the present disclosure.

Table 3 and Table 4 show design data of the camera optical lens 20 according to Example 2 of the present disclosure.

TABLE 3

| | R | d | | nd | | vd | |
|---|---|---|---|---|---|---|---|
| S1 | ∞ | d0= | −0.196 | | | | |
| R1 | 2.253 | d1= | 1.000 | nd1 | 1.5444 | ν1 | 55.82 |
| R2 | 135.290 | d2= | 0.054 | | | | |
| R3 | 6.185 | d3= | 0.220 | nd2 | 1.6700 | ν2 | 19.39 |
| R4 | 2.874 | d4= | 0.636 | | | | |
| R5 | 59.117 | d5= | 0.756 | nd3 | 1.5444 | ν3 | 55.82 |
| R6 | −15.027 | d6= | 0.497 | | | | |
| R7 | −35.370 | d7= | 1.000 | nd4 | 1.5444 | ν4 | 55.82 |
| R8 | −2.814 | d8= | 0.430 | | | | |
| R9 | 9.780 | d9= | 0.860 | nd5 | 1.5346 | ν5 | 55.69 |
| R10 | 1.633 | d10= | 0.481 | | | | |
| R11 | ∞ | d11= | 0.210 | ndg | 1.5168 | νg | 64.17 |
| R12 | ∞ | d12= | 0.213 | | | | |

Table 4 shows aspheric surface data of each lens in the camera optical lens 20 according to Example 2 of the present disclosure.

TABLE 4

| | Conic coefficient | Aspherical Coefficient | | | | |
|---|---|---|---|---|---|---|
| | k | A4 | A6 | A8 | A10 | A12 |
| R1 | 1.7445E−02 | −5.7196E−04 | 7.1092E−03 | −1.5888E−02 | 1.9639E−02 | −1.4227E−02 |
| R2 | 9.4766E+03 | −2.7500E−02 | 9.8217E−02 | −1.8841E−01 | 2.3700E−01 | −2.0373E−01 |
| R3 | 3.7155E+00 | −7.5071E−02 | 1.5984E−01 | −2.7105E−01 | 3.5424E−01 | −3.4049E−01 |
| R4 | −2.2186E+00 | −3.8285E−02 | 7.3619E−02 | −5.6764E−02 | −2.2473E−03 | 7.3783E−02 |
| R5 | 1.8112E+03 | −4.1344E−02 | −1.4302E−02 | 7.6058E−02 | −3.1622E−01 | 7.0857E−01 |
| R6 | 8.2684E+01 | −3.7840E−02 | −1.5261E−02 | 1.7138E−02 | −1.4997E−02 | −3.2108E−03 |
| R7 | 1.7148E+02 | −1.9805E−02 | −2.5993E−02 | 3.8134E−02 | −6.1475E−02 | 7.1234E−02 |
| R8 | −4.7244E−02 | −1.6211E−02 | −4.6093E−02 | 1.2895E−01 | −1.8751E−01 | 1.7602E−01 |
| R9 | 4.5063E+00 | −1.4185E−01 | 9.4881E−03 | 4.3057E−02 | −3.9239E−02 | 2.0856E−02 |
| R10 | −9.5485E−01 | −1.2961E−01 | 3.2290E−02 | 5.1053E−03 | −9.4359E−03 | 4.7152E−03 |
| | Conic coefficient | Aspherical Coefficient | | | | |
| | k | A14 | A16 | A18 | A20 | A22 |
| R1 | 1.7445E−02 | 5.4979E−03 | −9.0919E−04 | 0.0000E+00 | 0.0000E+00 | 0.0000E+00 |
| R2 | 9.4766E+03 | 1.1161E−01 | −3.4213E−02 | 4.0702E−03 | 1.0550E−04 | 0.0000E+00 |
| R3 | 3.7155E+00 | 2.3110E−01 | −1.0402E−01 | 2.8156E−02 | −3.6202E−03 | 0.0000E+00 |
| R4 | −2.2186E+00 | −8.3897E−02 | 4.2607E−02 | −8.4107E−03 | 0.0000E+00 | 0.0000E+00 |
| R5 | 1.8112E+03 | −9.7425E−01 | 8.3490E−01 | −4.3534E−01 | 1.2629E−01 | −1.5541E−02 |
| R6 | 8.2684E+01 | 1.8288E−02 | −1.7268E−02 | 8.1431E−03 | −1.9994E−03 | 2.0570E−04 |
| R7 | 1.7148E+02 | −5.7604E−02 | 3.2183E−02 | −1.2116E−02 | 2.9943E−03 | −4.6488E−04 |
| R8 | −4.7244E−02 | −1.1230E−01 | 4.9747E−02 | −1.5363E−02 | 3.2844E−03 | −4.7581E−04 |
| R9 | 4.5063E+00 | −7.5862E−03 | 1.9650E−03 | −3.6814E−04 | 5.0020E−05 | −4.8800E−06 |
| R10 | −9.5485E−01 | −1.4208E−03 | 2.9100E−04 | −4.2139E−05 | 4.3642E−06 | −3.2130E−07 |

| | |
|---|---|
| Conic coefficient | Aspherical Coefficient |

| | k | A24 | A26 | A28 | A30 |
|---|---|---|---|---|---|
| R1 | 1.7445E−02 | 0.0000E+00 | 0.0000E+00 | 0.0000E+00 | 0.0000E+00 |
| R2 | 9.4766E+03 | 0.0000E+00 | 0.0000E+00 | 0.0000E+00 | 0.0000E+00 |
| R3 | 3.7155E+00 | 0.0000E+00 | 0.0000E+00 | 0.0000E+00 | 0.0000E+00 |
| R4 | −2.2186E+00 | 0.0000E+00 | 0.0000E+00 | 0.0000E+00 | 0.0000E+00 |
| R5 | 1.8112E+03 | 0.0000E+00 | 0.0000E+00 | 0.0000E+00 | 0.0000E+00 |
| R6 | 8.2684E+01 | 0.0000E+00 | 0.0000E+00 | 0.0000E+00 | 0.0000E+00 |
| R7 | 1.7148E+02 | 4.1131E−05 | −1.5834E−06 | 0.0000E+00 | 0.0000E+00 |
| R8 | −4.7244E−02 | 4.4558E−05 | −2.4342E−06 | 5.8947E−08 | 0.0000E+00 |
| R9 | 4.5063E+00 | 3.3303E−07 | −1.5085E−08 | 4.0731E−10 | −4.9600E−12 |
| R10 | −9.5485E−01 | 1.6417E−08 | −5.5314E−10 | 1.1047E−11 | −9.9013E−14 |

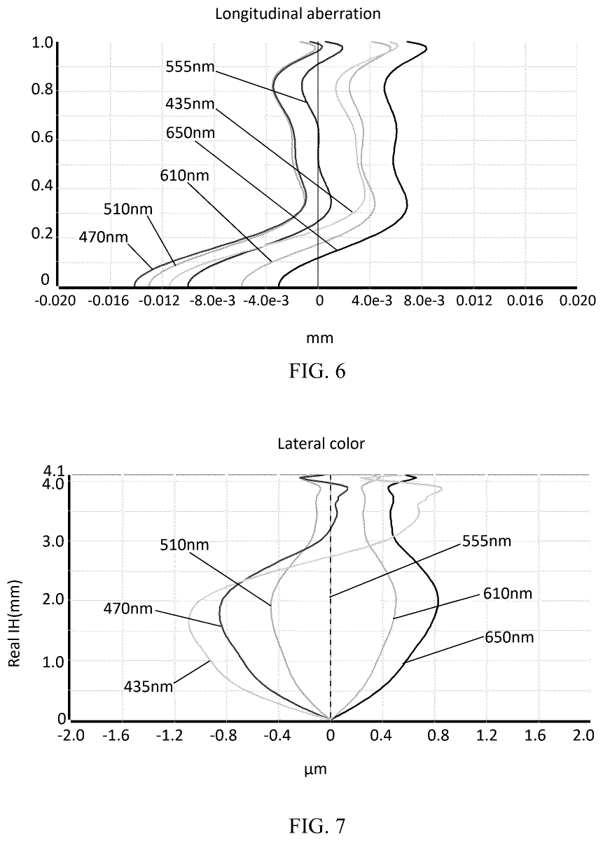

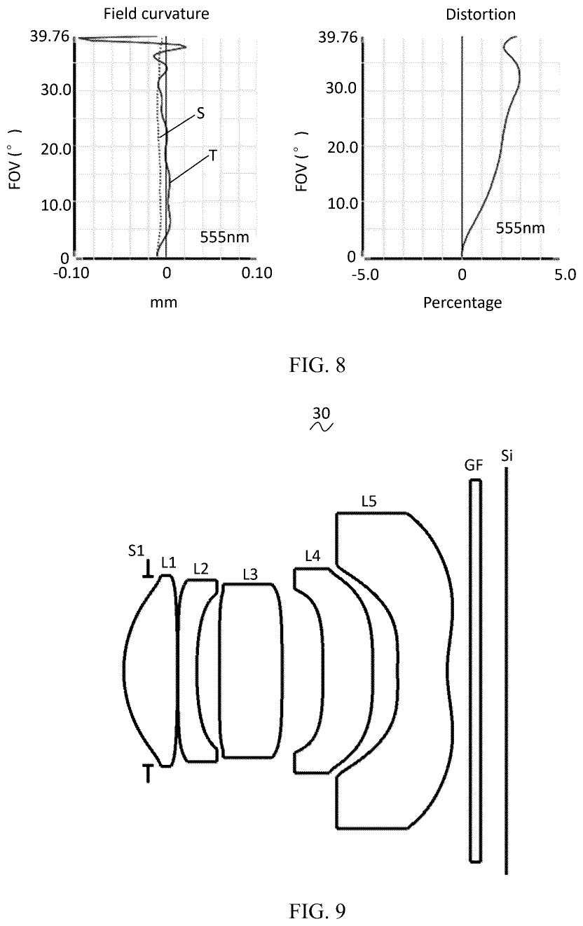

FIG. 6 and FIG. 7 respectively show longitudinal aberration and lateral color of light with wavelengths of 650 nm, 610 nm, 555 nm, 510 nm, 470 nm, and 435 nm after passing through the camera optical lens 20 according to Example 2. FIG. 8 shows field curvature and distortion of light with a wavelength of 555 nm after passing through the camera optical lens 20 according to Example 2. The field curvature S in FIG. 8 is the field curvature in the sagittal direction, and T is the field curvature in the meridian direction.

In this Example, an entrance pupil diameter ENPD of the camera optical lens 20 is 2.539 mm, a full field of view image height IH is 4.096 mm, and a field of view FOV in a diagonal direction of the full field of view is 79.51°. The camera optical lens 20 satisfies the design requirements of large aperture, wide-angle and ultra-thinness, and the on-axis and off-axis chromatic aberration thereof are fully corrected, and has good optical performance.

### Example 3

The meaning of the reference signs of Example 3 is the same as that of Example 1.

FIG. 9 shows a camera optical lens 30 according to Example 3 of the present disclosure. The fourth lens L4 has negative refractive power.

Table 5 and Table 6 show design data of the camera optical lens 30 according to Example 3 of the present disclosure.

TABLE 5

| | R | d | | nd | | vd | |
|---|---|---|---|---|---|---|---|
| S1 | ∞ | d0= | −0.494 | | | | |
| R1 | 2.492 | d1= | 1.081 | nd1 | 1.5444 | ν1 | 55.82 |
| R2 | 18.344 | d2= | 0.005 | | | | |
| R3 | 12.061 | d3= | 0.383 | nd2 | 1.6700 | ν2 | 19.39 |
| R4 | 6.555 | d4= | 0.458 | | | | |
| R5 | 231.335 | d5= | 1.259 | nd3 | 1.5444 | ν3 | 55.82 |
| R6 | −67.162 | d6= | 0.823 | | | | |
| R7 | −23.447 | d7= | 1.000 | nd4 | 1.5444 | ν4 | 55.82 |
| R8 | −34.104 | d8= | 0.498 | | | | |
| R9 | 16.188 | d9= | 0.997 | nd5 | 1.5346 | ν5 | 55.69 |
| R10 | 2.703 | d10= | 0.462 | | | | |
| R11 | ∞ | d11= | 0.210 | ndg | 1.5168 | νg | 64.17 |
| R12 | ∞ | d12= | 0.521 | | | | |

Table 6 shows aspheric surface data of each lens in the camera optical lens 30 according to Example 3 of the present disclosure.

TABLE 6

| | Conic coefficient | Aspherical Coefficient | | | | |
|---|---|---|---|---|---|---|
| | k | A4 | A6 | A8 | A10 | A12 |
| R1 | 2.6697E−01 | −2.8425E−03 | 2.5939E−03 | −8.4610E−03 | 1.1213E−02 | −8.6735E−03 |
| R2 | 4.6003E+01 | −2.1076E−01 | 5.0626E−01 | −7.0776E−01 | 6.1111E−01 | −3.3581E−01 |
| R3 | 1.1489E+01 | −1.7800E−01 | 4.6791E−01 | −7.0559E−01 | 6.6317E−01 | −3.9747E−01 |
| R4 | −2.6399E−01 | 8.6805E−03 | 1.3340E−02 | −1.7078E−02 | 2.0826E−02 | −1.5208E−02 |
| R5 | 9.9000E+01 | 2.1134E−03 | −5.3539E−03 | 1.2828E−02 | −1.1374E−02 | 4.2896E−03 |
| R6 | −9.9000E+01 | −1.1926E−02 | 1.3596E−02 | −2.7596E−02 | 3.1893E−02 | −2.3420E−02 |
| R7 | −9.8969E+01 | −3.0234E−02 | −4.2082E−02 | 1.3696E−01 | −2.4341E−01 | 2.4977E−01 |
| R8 | −9.8881E+01 | −9.4802E−02 | 9.0950E−02 | −1.1739E−01 | 1.0199E−01 | −5.6517E−02 |
| R9 | 2.7658E+00 | −1.8264E−01 | 1.1925E−01 | −1.1974E−01 | 9.5565E−02 | −5.0654E−02 |
| R10 | −9.7820E−01 | −1.2468E−01 | 5.3263E−02 | −1.9192E−02 | 4.9140E−03 | −8.4738E−04 |

| | Conic coefficient | Aspherical Coefficient | | | |
|---|---|---|---|---|---|
| | k | A14 | A16 | A18 | A20 |
| R1 | 2.6697E−01 | 3.9661E−03 | −1.0707E−03 | 1.5543E−04 | −9.3896E−06 |
| R2 | 4.6003E+01 | 1.1754E−01 | −2.5367E−02 | 3.0764E−03 | −1.6038E−04 |
| R3 | 1.1489E+01 | 1.5203E−01 | −3.5894E−02 | 4.7651E−03 | −2.7209E−04 |
| R4 | −2.6399E−01 | 7.6622E−03 | −2.5459E−03 | 5.3274E−04 | −5.3953E−05 |
| R5 | 9.9000E+01 | 1.1281E−03 | −1.6162E−03 | 5.5112E−04 | −6.6189E−05 |
| R6 | −9.9000E+01 | 1.0735E−02 | −2.9849E−03 | 4.5426E−04 | −2.8859E−05 |
| R7 | −9.8969E+01 | −1.5685E−01 | 5.9165E−02 | −1.2316E−02 | 1.0833E−03 |
| R8 | −9.8881E+01 | 1.9350E−02 | −3.9152E−03 | 4.2214E−04 | −1.8202E−05 |
| R9 | 2.7658E+00 | 1.6951E−02 | −3.4058E−03 | 3.7187E−04 | −1.6813E−05 |
| R10 | −9.7820E−01 | 9.5850E−05 | −6.8125E−06 | 2.7527E−07 | −4.8070E−09 |

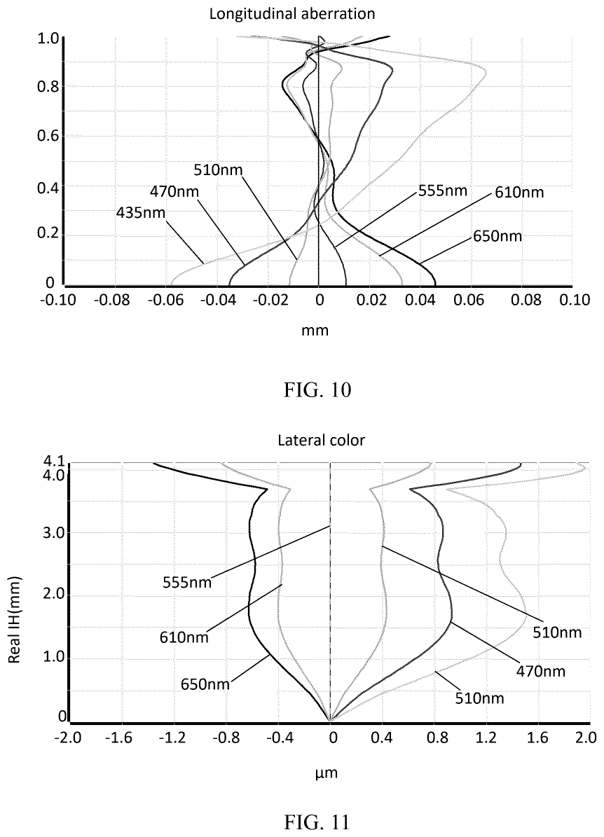

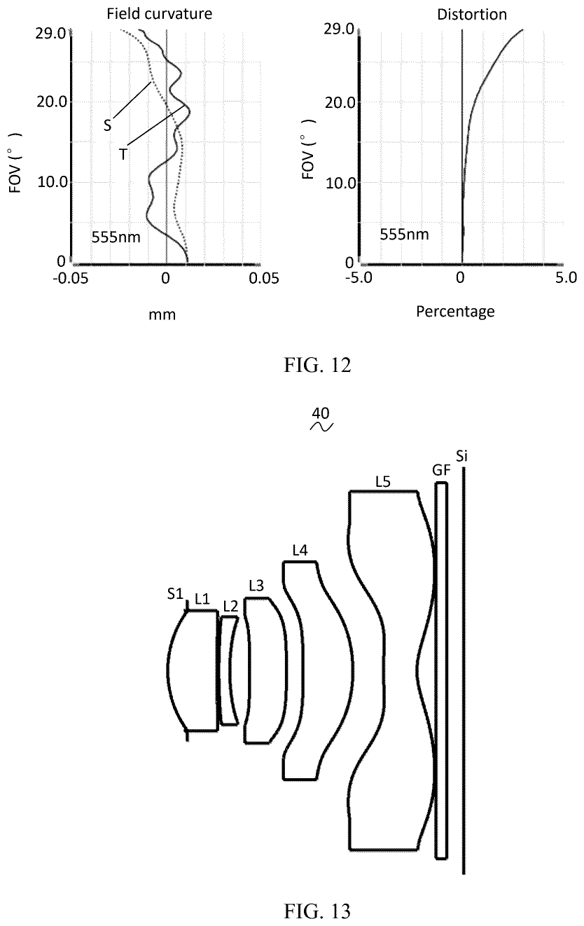

FIG. 10 and FIG. 11 show longitudinal aberration and lateral color of light with wavelengths of 650 nm, 610 nm, 555 nm, 510 nm, 470 nm, and 435 nm after passing through the camera optical lens 30 according to Example 3. FIG. 12 shows field curvature and distortion of light with a wavelength of 555 nm after passing through the camera optical lens 30 according to Example 3. The field curvature S in FIG. 12 is the field curvature in the sagittal direction, and T is the field curvature in the meridian direction.

In this Example, an entrance pupil diameter ENPD of the camera optical lens 30 is 3.827 mm, a full field of view image height IH is 4.096 mm, and a field of view FOV in a diagonal direction of the full field of view is 58.04°. The camera optical lens 30 satisfies the design requirements of large aperture, wide-angle and ultra-thinness, and the on-axis and off-axis chromatic aberration thereof are fully corrected, and has good optical performance.

### Example 4

The meaning of the reference signs of Example 4 is the same as that of Example 1.

FIG. 13 shows a camera optical lens 40 according to Example 4 of the present disclosure.

Table 7 and Table 8 show design data of the camera optical lens 40 according to Example 4 of the present disclosure.

TABLE 7

| | R | d | | nd | | vd | |
|---|---|---|---|---|---|---|---|
| S1 | ∞ | d0= | −0.394 | | | | |
| R1 | 2.041 | d1= | 0.987 | nd1 | 1.5444 | ν1 | 55.82 |
| R2 | 10.952 | d2= | 0.040 | | | | |
| R3 | 7.341 | d3= | 0.220 | nd2 | 1.6700 | ν2 | 19.39 |
| R4 | 3.692 | d4= | 0.396 | | | | |
| R5 | 140.401 | d5= | 0.744 | nd3 | 1.5444 | ν3 | 55.82 |
| R6 | −23.811 | d6= | 0.335 | | | | |
| R7 | −24.195 | d7= | 1.000 | nd4 | 1.5444 | ν4 | 55.82 |
| R8 | −2.917 | d8= | 0.614 | | | | |
| RS | 3.895 | d9= | 0.675 | nd5 | 1.5346 | ν5 | 55.69 |
| R10 | 1.338 | d10= | 0.386 | | | | |
| R11 | ∞ | d11= | 0.210 | ndg | 1.5168 | νg | 64.17 |
| R12 | ∞ | d12= | 0.344 | | | | |

Table 8 shows aspheric surface data of each lens in the camera optical lens 40 according to Example 4 of the present disclosure.

TABLE 8

| | Conic coefficient | Aspherical Coefficient | | | | |
|---|---|---|---|---|---|---|
| | k | A4 | A6 | A8 | A10 | A12 |
| R1 | 5.9312E−02 | −1.0480E−03 | 9.3476E−03 | −3.0091E−02 | 6.7005E−02 | −9.7840E−02 |
| R2 | −7.2148E+02 | −6.2837E−02 | 1.5677E−01 | −1.5696E−01 | 2.5957E−02 | 5.8389E−02 |
| R3 | −2.8386E+02 | −7.0852E−02 | 1.9842E−01 | −1.8370E−01 | 3.1307E−04 | 1.1553E−01 |
| R4 | −7.7009E+00 | −2.7246E−02 | 7.3172E−02 | 1.6206E−01 | −7.0125E−01 | 9.0344E−01 |
| R5 | 2.2922E+03 | −4.6083E−02 | −4.1401E−02 | 1.1304E−01 | −1.5975E−01 | −2.8933E−02 |
| R6 | 2.2513E+02 | −5.4251E−02 | 1.6058E−02 | −4.5756E−02 | 3.5943E−02 | −9.6986E−03 |
| R7 | 1.2621E+02 | −2.4988E−02 | −4.5388E−02 | 6.7206E−02 | −6.2168E−02 | 2.2139E−02 |
| R8 | 0.0000E+00 | −2.8521E−02 | −5.2176E−02 | 1.8869E−01 | −2.8439E−01 | 2.3743E−01 |
| R9 | 0.0000E+00 | −2.5070E−01 | 1.0842E−01 | −2.8941E−02 | −1.8371E−03 | 6.7045E−03 |
| R10 | −1.0000E+00 | −2.5442E−01 | 1.6135E−01 | −8.9678E−02 | 4.0143E−02 | −1.3934E−02 |
| | Conic coefficient | Aspherical Coefficient | | | | |
| | k | A14 | A16 | A18 | A20 | A22 |
| R1 | 5.9312E−02 | 8.4988E−02 | −3.2460E−02 | −7.7696E−03 | 9.7640E−03 | 1.1656E−03 |
| R2 | −7.2148E+02 | −1.1869E−02 | −2.7963E−02 | −3.2654E−03 | 1.2575E−02 | 7.7033E−03 |
| R3 | −2.8386E+02 | −3.2119E−02 | −3.7658E−02 | 1.1487E−02 | −2.4713E−02 | 4.8093E−02 |
| R4 | −7.7009E+00 | −1.0788E−01 | −6.0422E−01 | 1.0746E−03 | 5.0786E−01 | 1.8057E−01 |
| R5 | 2.2922E+03 | 2.9647E−01 | −2.5256E−01 | −1.0108E−02 | 8.7984E−02 | −2.3265E−02 |
| R6 | 2.2513E+02 | −4.5946E−03 | 1.9497E−03 | 9.9710E−04 | −3.0325E−05 | −2.1213E−04 |
| R7 | 1.2621E+02 | 1.8874E−03 | −1.8492E−03 | −4.3617E−04 | 1.9222E−04 | 1.3606E−05 |
| R8 | 0.0000E+00 | −9.9301E−02 | −3.3164E−03 | 2.9012E−02 | −1.7599E−02 | 5.7819E−03 |
| R9 | 0.0000E+00 | −3.5923E−03 | 1.1443E−03 | −2.5456E−04 | 4.1499E−05 | −4.9687E−06 |
| R10 | −1.0000E+00 | 3.6830E−03 | −7.3478E−04 | 1.0987E−04 | −1.2189E−05 | 9.8562E−07 |
| | Conic coefficient | Aspherical Coefficient | | | | |
| | k | A24 | A26 | A28 | A30 | A32 |
| R1 | 5.9312E−02 | −3.6206E−03 | 1.2990E−03 | −1.3756E−04 | 0.0000E+00 | 0.0000E+00 |
| R2 | −7.2148E+02 | −3.4719E−03 | −6.8409E−03 | −6.3273E−04 | 5.5877E−03 | −2.0121E−03 |
| R3 | −2.8386E+02 | −1.7201E−02 | −7.3162E−03 | 3.8105E−03 | 0.0000E+00 | 0.0000E+00 |
| R4 | −7.7009E+00 | −4.6393E−01 | −1.7861E−02 | 3.8876E−02 | 1.6189E−01 | −8.0965E−02 |
| R5 | 2.2922E+03 | 1.5280E−02 | −2.2123E−02 | 7.5636E−03 | 0.0000E+00 | 0.0000E+00 |
| R6 | 2.2513E+02 | −1.0240E−04 | 5.0589E−05 | 5.2935E−06 | 4.2304E−06 | −2.2870E−06 |
| R7 | 1.2621E+02 | 1.1614E−05 | −4.7323E−06 | −2.4771E−06 | 1.0509E−06 | −1.0145E−07 |
| R8 | 0.0000E+00 | −1.1755E−03 | 1.4797E−04 | −1.0618E−05 | 3.3321E−07 | 0.0000E+00 |
| R9 | 0.0000E+00 | 4.2479E−07 | −2.4448E−08 | 8.4521E−10 | −1.3218E−11 | 0.0000E+00 |
| R10 | −1.0000E+00 | −5.6312E−08 | 2.1501E−09 | −4.9153E−11 | 5.0819E−13 | 0.0000E+00 |

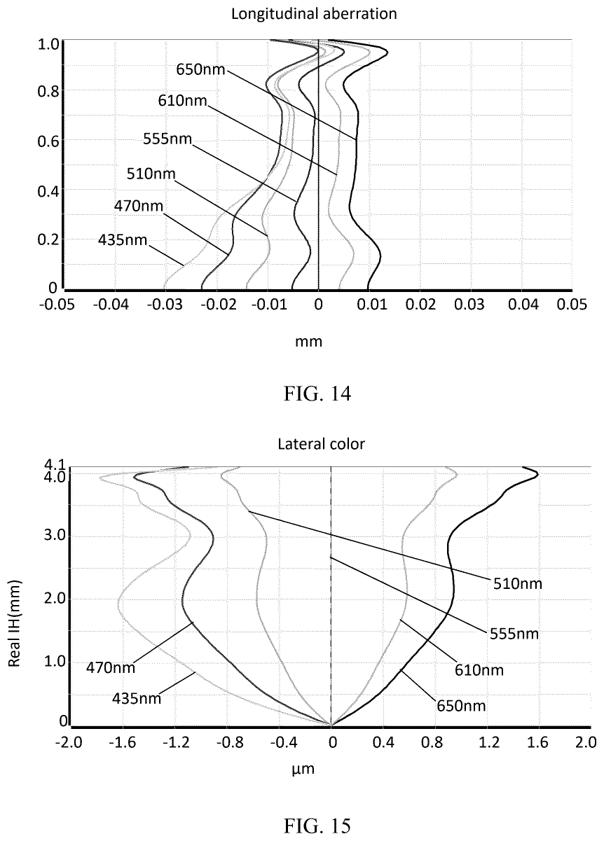

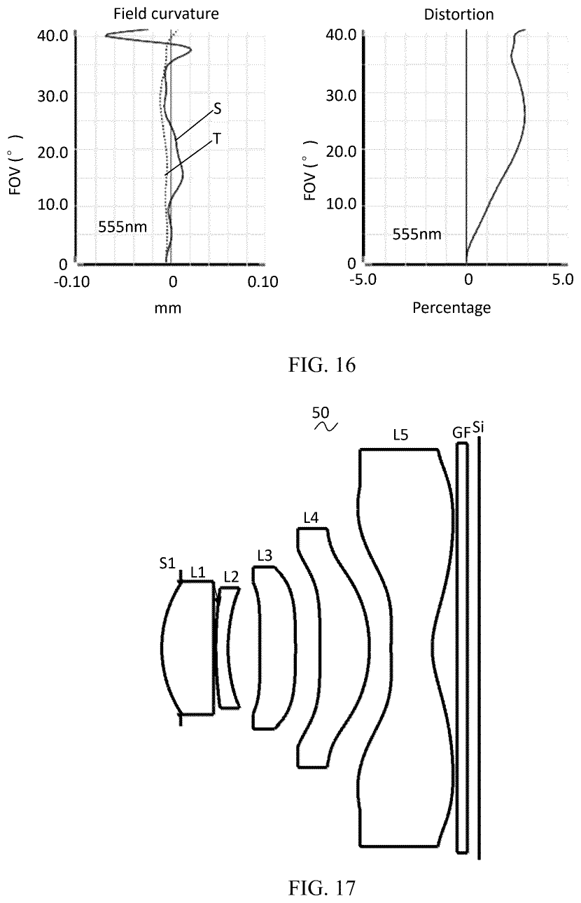

FIG. 14 and FIG. 15 respectively show longitudinal aberration and lateral color of light with wavelengths of 650 nm, 610 nm, 555 nm, 510 nm, 470 nm, and 435 nm after passing through the camera optical lens 40 according to Example 4. FIG. 16 shows field curvature and distortion of light with a wavelength of 555 nm after passing through the camera optical lens 40 according to Example 3. The field curvature S in FIG. 16 is the field curvature in the sagittal direction, and T is the field curvature in the meridian direction.

In this Example, an entrance pupil diameter ENPD of the camera optical lens 40 is 2.417 mm, the full field of view image height IH is 4.096 mm, and a field of view FOV in a diagonal direction of the full field of view is 82.33°. The camera optical lens 40 satisfies the design requirements of large aperture, wide-angle and ultra-thinness, and the on-axis and off-axis chromatic aberration thereof are fully corrected, and has good optical performance.

Table 11 shows various values in Example 1, Example 2, Example 3, Example 4, and values corresponding to the parameters specified in the relational expressions.

### COMPARATIVE EXAMPLE

The meaning of the reference signs of Comparative Example is the same as that of Example 1.

FIG. 17 shows a camera optical lens 50 according to Comparative Example of the present disclosure.

Table 9 and Table 10 show design data of the camera optical lens 50 according to Comparative Example in the present disclosure.

TABLE 9

| | R | d | | nd | | vd | |
|---|---|---|---|---|---|---|---|
| S1 | ∞ | d0= | −0.381 | | | | |
| R1 | 2.249 | d1= | 1.040 | nd1 | 1.5444 | ν1 | 55.82 |
| R2 | 120.452 | d2= | 0.049 | | | | |
| R3 | 6.189 | d3= | 0.245 | nd2 | 1.6700 | ν2 | 19.39 |
| R4 | 2.879 | d4= | 0.640 | | | | |
| R5 | 56.452 | d5= | 0.719 | nd3 | 1.5444 | ν3 | 55.82 |
| R6 | −23.910 | d6= | 0.494 | | | | |
| R7 | −36.110 | d7= | 0.993 | nd4 | 1.5444 | ν4 | 55.82 |
| R8 | −2.731 | d8= | 0.436 | | | | |
| R9 | 8.980 | d9= | 0.829 | nd5 | 1.5346 | ν5 | 55.69 |
| R10 | 1.654 | d10= | 0.501 | | | | |
| R11 | ∞ | d11= | 0.210 | ndg | 1.5168 | νg | 64.17 |
| R12 | ∞ | d12= | 0.232 | | | | |

Table 10 shows aspherical surface data of each lens in the camera optical lens 50 according to Comparative Example in the present disclosure.

TABLE 10

| | Conic coefficient | Aspherical Coefficient | | | | |
|---|---|---|---|---|---|---|
| | k | A4 | A6 | A8 | A10 | A12 |
| R1 | 3.2365E−02 | −2.6867E−05 | 3.6340E−03 | −7.4650E−03 | 8.8017E−03 | −6.1896E−03 |
| R2 | 9.4454E+03 | −3.8718E−02 | 1.5315E−01 | −3.5579E−01 | 5.9873E−01 | −7.3186E−01 |
| R3 | 4.0586E+00 | −8.0813E−02 | 1.9017E−01 | −3.5785E−01 | 5.2113E−01 | −5.5555E−01 |
| R4 | −2.2152E+00 | −3.7383E−02 | 7.7109E−02 | −8.2097E−02 | 5.8831E−02 | −5.6763E−03 |
| R5 | 1.8112E+03 | −4.5939E−02 | 5.1923E−03 | −5.5701E−03 | −8.9183E−02 | 3.0900E−01 |
| R6 | 1.5758E+02 | −4.2453E−02 | −1.0247E−02 | 2.0986E−02 | −4.5134E−02 | 5.2202E−02 |
| R7 | 1.6467E+02 | −2.0933E−02 | −2.4874E−02 | 4.3157E−02 | −7.4880E−02 | 8.8252E−02 |
| R8 | −6.8274E−02 | −1.7492E−02 | −3.8826E−02 | 1.2487E−01 | −1.9671E−01 | 1.9628E−01 |
| R9 | 4.0792E+00 | −1.4613E−01 | 2.8676E−02 | 1.5485E−02 | −1.6628E−02 | 8.5665E−03 |
| R10 | −9.4981E−01 | −1.3522E−01 | 4.6700E−02 | −1.1512E−02 | 1.7392E−03 | −1.8968E−04 |
| | Conic coefficient | Aspherical Coefficient | | | | |
| | k | A14 | A16 | A18 | A20 | A22 |
| R1 | 3.2365E−02 | 2.3186E−03 | −3.7654E−04 | 0.0000E+00 | 0.0000E+00 | 0.0000E+00 |
| R2 | 9.4454E+03 | 6.1577E−01 | −3.3478E−01 | 1.0553E−01 | −1.4689E−02 | 0.0000E+00 |
| R3 | 4.0586E+00 | 4.1274E−01 | −2.0103E−01 | 5.8055E−02 | −7.6532E−03 | 0.0000E+00 |
| R4 | −2.2152E+00 | −2.5187E−02 | 1.9185E−02 | −4.4120E−03 | 0.0000E+00 | 0.0000E+00 |
| R5 | 1.8112E+03 | −5.2433E−01 | 5.1346E−01 | −2.9525E−01 | 9.2666E−02 | −1.2195E−02 |
| R6 | 1.5758E+02 | −3.6956E−02 | 1.5902E−02 | −3.8591E−03 | 4.2074E−04 | −3.7091E−06 |
| R7 | 1.6467E+02 | −7.1790E−02 | 4.0570E−02 | −1.5657E−02 | 4.0276E−03 | −6.6030E−04 |
| R8 | −6.8274E−02 | −1.3186E−01 | 6.1201E−02 | −1.9759E−02 | 4.4139E−03 | −6.6838E−04 |
| R9 | 4.0792E+00 | −2.8797E−03 | 6.6178E−04 | −1.0526E−04 | 1.1527E−05 | −8.4496E−07 |
| R10 | −9.4981E−01 | 5.9656E−05 | −2.4752E−05 | 6.0725E−06 | −9.1627E−07 | 8.9543E−08 |

| | Conic coefficient | Aspherical Coefficient | | | |
|---|---|---|---|---|---|
| | k | A24 | A26 | A28 | A30 |
| R1 | 3.2365E−02 | 0.0000E+00 | 0.0000E+00 | 0.0000E+00 | 0.0000E+00 |
| R2 | 9.4454E+03 | 0.0000E+00 | 0.0000E+00 | 0.0000E+00 | 0.0000E+00 |
| R3 | 4.0586E+00 | 0.0000E+00 | 0.0000E+00 | 0.0000E+00 | 0.0000E+00 |
| R4 | −2.2152E+00 | 0.0000E+00 | 0.0000E+00 | 0.0000E+00 | 0.0000E+00 |
| R5 | 1.8112E+03 | 0.0000E+00 | 0.0000E+00 | 0.0000E+00 | 0.0000E+00 |
| R6 | 1.5758E+02 | 0.0000E+00 | 0.0000E+00 | 0.0000E+00 | 0.0000E+00 |
| R7 | 1.6467E+02 | 6.2458E−05 | −2.5963E−06 | 0.0000E+00 | 0.0000E+00 |
| R8 | −6.8274E−02 | 6.5471E−05 | −3.7442E−06 | 9.4980E−08 | 0.0000E+00 |
| R9 | 4.0792E+00 | 3.8610E−08 | −9.0397E−10 | 2.3071E−12 | 2.3138E−13 |
| R10 | −9.4981E−01 | −5.7222E−09 | 2.3168E−10 | −5.4059E−12 | 5.5456E−14 |

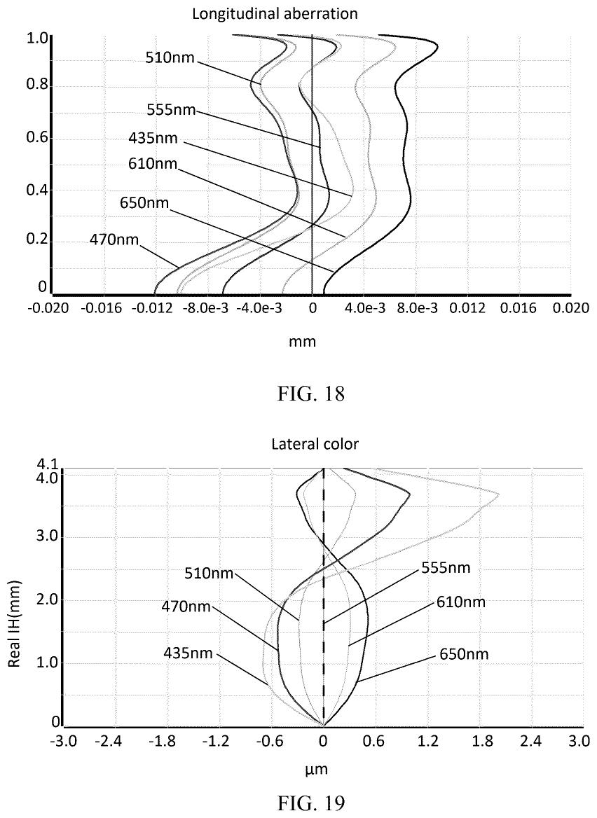

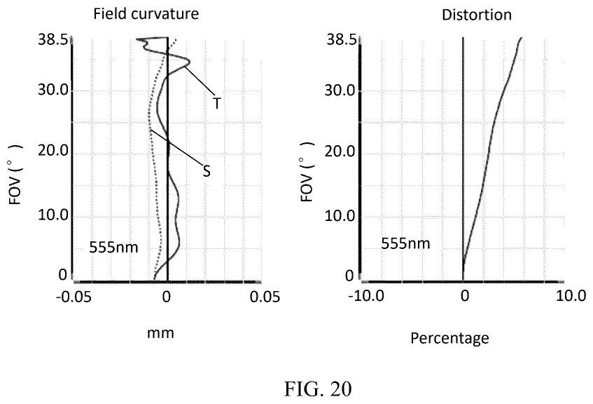

FIG. 18 and FIG. 19 show longitudinal aberration and lateral color of light with wavelengths of 650 nm, 610 nm, 555 nm, 510 nm, 470 nm, and 435 nm after passing the camera optical lens 50 according to Comparative Example. FIG. 20 shows field curvature and distortion of light with a wavelength of 555 nm after passing through the camera optical lens 50 according to the Comparative Example. The field curvature S in FIG. 20 is the field curvature in the sagittal direction, and T is the field curvature in the meridian direction.

Table 11 below lists values corresponding to each relational expression in Comparative Example according to the above relational expressions. The camera optical lens 60 of Comparative Example does not satisfy the above relational expression 0.50≤(R5+R6)/(R5−R6)≤0.81, resulting in poor imaging performance.

In the Comparative Example, an entrance pupil diameter ENPD of the camera optical lens 50 is 2.583 mm, a full field of view image height IH is 4.091 mm, and a field of view FOV in the diagonal direction is 76.95°, the camera optical lens 50 does not satisfy the design requirements of large-aperture, wide-angle and ultra-thinness.

TABLE 11

| Parameters and | | | | | Compar- |
|---|---|---|---|---|---|
| Relational | Exam- | Exam- | Exam- | Exam- | ative |
| Expressions | ple 1 | ple 2 | ple 3 | ple 4 | Example |
| (R5 + R6)/ | 0.81 | 0.59 | 0.55 | 0.71 | 0.40 |
| (R5 − R6) | | | | | |
| (f2 + f5)/f | −3.26 | −2.50 | −3.90 | −3.40 | −2.50 |
| d9/d8 | 1.11 | 2.00 | 2.00 | 1.10 | 1.90 |
| R9/R10 | 2.86 | 5.99 | 5.99 | 2.91 | 5.43 |
| (R7 + R8)/f | −4.20 | −8.00 | −8.00 | −5.97 | −8.00 |
| f | 2.337 | 2.082 | 2.544 | 2.256 | 2.603 |
| f1 | 4.864 | 4.774 | 7.194 | 4.543 | 4.855 |
| f2 | 4.435 | 4.183 | 5.156 | 4.419 | 4.184 |
| f3 | −11.747 | −8.156 | −21.846 | −11.261 | −8.204 |
| f4 | 30.682 | 22.016 | 95.442 | 37.334 | 30.849 |
| f5 | 6.361 | 5.537 | −142.095 | 5.973 | 5.354 |
| f12 | −4.087 | −3.795 | −6.210 | −4.186 | −3.934 |
| FNO | 1.880 | 1.880 | 1.880 | 1.880 | 1.880 |
| TTL | 5.930 | 6.357 | 7.697 | 5.951 | 6.388 |

Those skilled in the art can understand that the above embodiments are specific embodiments for implementing the present disclosure, and in practical applications, various changes may be made in form and detail without departing from the spirit and scope of the present disclosure.

What is claimed is:

1. A camera optical lens, comprising five lenses from an object side to an image side in sequence: a first lens having positive refractive power, a second lens having negative refractive power, a third lens having positive refractive power, a fourth lens having refractive power, and a fifth lens having negative refractive power; and
wherein a focal length of the camera optical lens is defined as f, a focal length of the second lens is f2, a focal length of the fifth lens is f5, an on-axis distance from an image side surface of the fourth lens to an object side surface of the fifth lens is defined as d8, an on-axis thickness of the fifth lens is defined as d9, a central curvature radius of an object side surface of the third lens is defined as R5, and a central curvature radius of an image side surface of the third lens is defined as R6, a central curvature radius of an object side surface of the fourth lens is defined as R7, a central curvature radius of an image side surface of the fourth lens is defined as R8, a central curvature radius of an object side surface of the fifth lens is defined as R9, a central curvature radius of an image side surface of the fifth lens is defined as R10, and following relational expressions are satisfied:
$$0.5 \leq ( R 5 + R 6 ) / ( R 5 - R 6 ) \leq 0.81 ;$$
$$- 4. 0 \leq ( f 2 + f 5 ) / f \leq - 2 \text{.50} ;$$
$$0.6 \leq d 9 / d 8 \leq 2 \text{.00} ;$$
$$2.8 \leq R 9 / R 10 \leq 6. ; and$$
$$- 8. 0 \leq ( R 7 + R 8 ) / f \leq - 4.00 .$$

2. The camera optical lens as described in claim 1, wherein an on-axis thickness of the second lens is defined as d3, an on-axis thickness of the third lens is defined as d5, an on-axis thickness of the fourth lens is defined as d7, and a following relational expression is satisfied:
$$5. \leq ( d 5 + d 7 ) / d 3 \leq 8.00 .$$

3. The camera optical lens as described in claim 1, wherein a total optical length from an object side surface of the first lens to an image plane of the camera optical lens along an optic axis is defined as TTL, and a following relational expression is satisfied:
$$1.05 \leq TTL / f \leq 1.35 .$$

4. The camera optical lens as described in claim 1, wherein an object side surface of the first lens is convex in a paraxial region, and an image side surface of the first lens is concave in the paraxial region; and
a focal length of the first lens is defined as f1, a central curvature radius of the object side surface of the first lens is defined as R1, a central curvature radius of the image side surface of the first lens is defined as R2, an on-axis thickness of the first lens is defined as d1, a total optical length from an object side surface of the first lens to an image plane of the camera optical lens along an optic axis is defined as TTL, and following relational expressions are satisfied:
$$0.36 \leq f 1 / f \leq 1.46 ;$$
$$- 3.2 \leq ( R 1 + R 2 ) / ( R 1 - R 2 ) \leq - 0 \text{.69} ; and$$
$$0.07 \leq d 1 / TTL \leq 0.25 .$$

5. The camera optical lens as described in claim 1, wherein an object side surface of the second lens is convex in a paraxial region, and an image side surface of the second lens is concave in the paraxial region; and
a central curvature radius of an object side surface of the second lens is defined as R3, a central curvature radius of an image side surface of the second lens is defined as R4, an on-axis thickness of the second lens is d3, and a total optical length from an object side surface of the first lens to an image plane of the camera optical lens along an optic axis is defined as TTL, and following relational expressions are satisfied:
$$- 6.07 \leq f 2 / f \leq - 1.14 ;$$
$$1.37 \leq ( R 3 + R 4 ) / ( R 3 - R 4 ) \leq 5.07 ; and$$
$$0.02 \leq d 3 / TTL \leq 0.08 .$$

6. The camera optical lens as described in claim 1, wherein an object side surface of the third lens is convex in a paraxial region, and an image side surface of the third lens is convex in the paraxial region; and
a focal length of the third lens is defined as f3, an on-axis thickness of the third lens is defined as d5, and a total optical length from an object side surface of the first lens to an image plane of the camera optical lens along an optic axis is defined as TTL, and following relational expressions are satisfied:
$$2.31 \leq f 3 / f \leq 19.9 ; and$$
$$0.06 \leq d 5 / TTL \leq 0.25 .$$

7. The camera optical lens as described in claim 1, wherein an object side surface of the fourth lens is concave in a paraxial region, and an image side surface of the fourth lens is convex in the paraxial region; and
a focal length of the fourth lens is f4, and an on-axis thickness of the fourth lens is defined as d7, and a total optical length from an object side surface of the first lens to an image plane of the camera optical lens along an optic axis is defined as TTL, and following relational expressions are satisfied:
$$- 39.50 \leq f 4 / f \leq 1.97 ;$$
$$- 10. 80 \leq ( R 7 + R 8 ) / ( R 7 - R 8 ) \leq 2.11 ; and$$
$$0.06 \leq d 7 / TTL \leq 0.25 .$$

8. The camera optical lens as described in claim 1, wherein an object side surface of the fifth lens is convex in a paraxial region, and an image side surface of the fifth lens is concave in the paraxial region; and
a total optical length from an object side surface of the first lens to an image plane of the camera optical lens along an optic axis is defined as TTL, and following relational expressions are satisfied:
$$- 1.84 \leq f 5 / f \leq - 0.53 ; and$$
$$0.05 \leq d 9 / TTL \leq 0.20 .$$

9. The camera optical lens as described in claim 1, wherein a total optical length from an object side surface of the first lens to an image plane of the camera optical lens along an optic axis is defined as TTL, and a maximum image height of the camera optical lens is defined as IH, and a following relational expression is satisfied:
$$TTL / IH \leq 1.79 .$$

10. The camera optical lens as described in claim 1, wherein a combined focal length of the first lens and the second lens is defined as f12, and a following relational expression is satisfied:
$$0.43 \leq f 12 / f \leq 2.17 .$$
